(19) United States
(12) Patent Application Publication
(10) Pub. No.: US 2015/0193529 A1
(43) Pub. Date: Jul. 9, 2015

(54) OPINION ANALYZING SYSTEM AND METHOD

(71) Applicant: Electronics and Telecommunications Research Institute, Daejeon (KR)

(72) Inventors: Yo Han JO, Daejeon (KR); Hyun Ki KIM, Daejeon (KR); Pum Mo RYU, Daejeon (KR); Hyo Jung OH, Daejeon (KR); Yeo Chan YOON, Daejeon (KR); Chung Hee LEE, Daejeon (KR); Soo Jong LIM, Daejeon (KR); Myung Gil JANG, Daejeon (KR); Mi Ran CHOI, Daejeon (KR); Yoon Jae CHOI, Daejeon (KR); Jeong HEO, Daejeon (KR)

(73) Assignee: Electronics and Telecommunications Research Institute, Daejeon (KR)

(21) Appl. No.: 14/257,265

(22) Filed: Apr. 21, 2014

(30) Foreign Application Priority Data
Jan. 8, 2014 (KR) 10-2014-0002410

(51) Int. Cl. G06F 17/30

(52) U.S. Cl. CPC G06F 17/30707; G06F 17/30265

(57) ABSTRACT

Provided are an opinion analyzing system and method that analyze an opinion change based on an elapse of time and provide an analysis result. The opinion analyzing system includes a user terminal configured to transmit an opinion analysis request signal including an opinion analysis target keyword and analysis target period information, and an opinion analyzing server configured to, when the opinion analysis request signal is received from the user terminal, collect text information including the opinion analysis target keyword from a database according to the opinion analysis request signal, and analyze the collected text information to generate a summary text of an opinion.

### CROSS-REFERENCE TO RELATED APPLICATIONS

This application claims priority under 35 U.S.C. §119 to Korean Patent Application No. 10-2014-0002410, filed on Jan. 8, 2014, the disclosure of which is incorporated herein by reference in its entirety.

### TECHNICAL FIELD

The present invention relates to an opinion analyzing system and method that analyze an opinion change based on an elapse of time and provide an analysis result.

### BACKGROUND

As the number of users of social media such as Blog, Twitter, Facebook, etc. increases rapidly, texts expressing an opinion (expression) about a specific event, product, and policy are exponentially increasing.

Such an opinion is an important factor for a strategic plan of a company, which plans an event or a product, or an institute that establishes a policy.

In particular, examples of opinions which are changed with time includes a case, which establishes a marketing strategy by checking a change in a company image, and a case which analyzes public opinion about a policy to establish an appropriate counterstrategy.

Moreover, positive or negative images of candidates are shown in social media during an election period, and are analyzed and used as a news article.

An analysis of a large amount of opinion is proposed as an alternative of the existing survey of public opinion which is made for a small-scale population sample, and thus is high in reliability. Therefore, the analysis is expected to be applied to various fields.

However, although an opinion analyzing method is needed, a related art opinion analyzing method cannot analyze a cause by which various opinions are changed with time, and moreover cannot provide a basis of an analysis result.

### SUMMARY

Accordingly, the present invention provides an opinion analyzing system and method based on an elapse of time, which analyze a change progress of opinion, and provide a basis of an opinion analysis result by using a text and an image, thereby intuitively recognizing opinion information, analyzed from a large number of texts, and an opinion change based on an elapse of time.

In one embodiment, an opinion analyzing server based on an elapse of time includes: a communication unit configured to receive an opinion analysis request signal, including an opinion analysis target keyword and analysis target period information, from a user terminal; a collection unit configured to collect text information including the opinion analysis target keyword from a database according to the opinion analysis request signal which is received through the communication unit; and an opinion analyzing unit configured to analyze the text information collected by the collection unit, and provide opinion information according to the analysis result.

The opinion analyzing unit may classify, by predetermined category, the text information collected by the collection unit, and digitize an amount of the text information by category to analyze the text information.

The opinion analyzing unit may count number of matches between words included in the text information collected by the collection unit and predetermined core words by category, and classify the text information by category according to the count result.

The opinion analyzing server may further include a summary text generating unit configured to generate a summary text according to the text information analysis result of the opinion analyzing unit.

The summary text generating unit may cluster the text information collected by the collection unit by using a clustering algorithm, and generate the summary text by using the clustered text information.

The collection unit may collect the text information from web data which is described in a natural language, and collect image information associated with the opinion analysis target keyword.

The opinion analyzing server may further include a summary image generating unit configured to generate a summary image by using the image information collected by the collection unit according to the text information analysis result of the opinion analyzing unit.

In another embodiment, an opinion analyzing method based on an elapse of time includes: setting a keyword and search period of an opinion analysis target; analyzing text information of an opinion based on the set keyword and search period; and providing, as a graph and a summary text, opinion information about the analysis result of the text information.

The analyzing may include: collecting text information which is generated during the set search period and includes the set keyword; classifying the collected text information by predetermined category; and digitizing an amount of the classified text information by category to analyze the text information.

The analyzing may include: counting number of matches between words included in the collected text information and predetermined words by category; and when the number of matches is equal to or greater than predetermined number of times, classifying the text information as a category corresponding to the predetermined words.

The providing of opinion information may include generating a graph of an amount of the text information by category based on time by using the analysis result of the text information.

The opinion analyzing method may further include collecting image information associated with the keyword, and generating and providing a summary image according to the analysis result of the text information.

The providing of opinion information may include clustering the collected text information by using a clustering algorithm, and selecting and providing representative text information from among pieces of the clustered text information, or listing words, which are included in the clustered text information a predetermined number of times or more, to provide a summary text.

In yet another embodiment, an opinion analyzing system based on an elapse of time includes: a user terminal configured to transmit an opinion analysis request signal including an opinion analysis target keyword and analysis target period information; and an opinion analyzing server configured to, when the opinion analysis request signal is received from the user terminal, collect text information including the opinion analysis target keyword from a database according to the opinion analysis request signal, and analyze the collected text information to generate a summary text of an opinion.

The opinion analyzing server may classify the collected text information by predetermined category, and digitize an amount of the text information by category to analyze the text information.

The opinion analyzing server may compare predetermined words by category and words included in the collected text information to count number of matches therebetween, and when the number of matches is equal to or greater than predetermined number of times, classify the text information as a corresponding category.

The opinion analyzing server may generate a graph of an amount of the text information by category based on time according to the analysis result of the text information.

The opinion analyzing server may select representative text information from among pieces of the text information according to the analysis result of the text information, or list words, which are included in the text information a predetermined number of times or more, to generate the summary text.

The opinion analyzing server may collect image information associated with the opinion analysis target keyword from the database, and generate a summary image by using the collected image information.

Other features and aspects will be apparent from the following detailed description, the drawings, and the claims.

### BRIEF DESCRIPTION OF THE DRAWINGS

FIG. 1 is a block diagram illustrating a configuration of an opinion analyzing system based on an elapse of time according to an embodiment of the present invention.

FIG. 2 is a block diagram illustrating a configuration of a user terminal of FIG. 1.

FIG. 3 is a Nock diagram illustrating a configuration of an opinion analyzing server of FIG. 1.

FIG. 4 is an exemplary diagram illustrating an opinion analysis result according to an embodiment of the present invention.

FIGS. 5 and 6 are exemplary diagrams showing graphs of a change progress of single opinion according to an embodiment of the present invention.

FIG. 7 is an exemplary diagram showing a graph of change progresses of a plurality of opinions according to an embodiment of the present invention.

FIGS. 8 to 10 are exemplary diagrams illustrating a summary text of an opinion analysis result according to an embodiment of the present invention.

FIG. 11 is an exemplary diagram illustrating a summary image of an opinion analysis result according to an embodiment of the present invention.

FIG. 12A to 12E is an exemplary diagram illustrating an opinion analysis result based on an elapse of time according to an embodiment of the present invention.

FIG. 13 is a flowchart illustrating an opinion analyzing method based on an elapse of time according to an embodiment of the present invention.

FIG. 14 is a flowchart illustrating a process of selecting a representative document in an opinion analyzing method based on an elapse of time according to an embodiment of the present invention.

FIG. 15 is a flowchart illustrating a process of extracting a title of a representative news article in an opinion analyzing method based on an elapse of time according to an embodiment of the present invention.

### DETAILED DESCRIPTION OF EMBODIMENTS

Hereinafter, embodiments of the present invention will be described in detail with reference to the accompanying drawings.

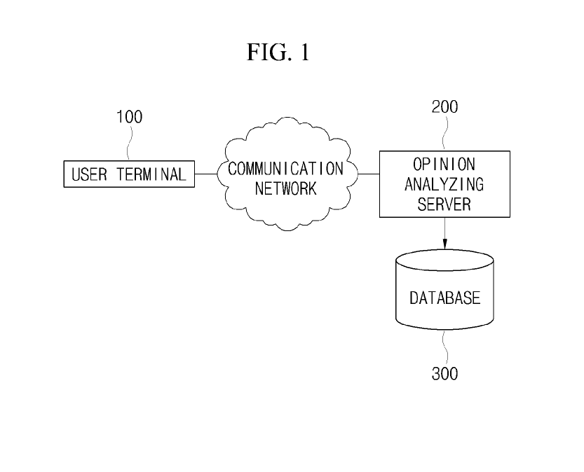

FIG. 1 is a block diagram illustrating a configuration of an opinion analyzing system based on an elapse of time according to an embodiment of the present invention.

Referring to FIG. 1, the opinion analyzing system based on an elapse of time according to an embodiment of the present invention includes a user terminal 100, an opinion analyzing server 200 which is connected to the user terminal 100 over a communication network, and a database 300 which interoperates with the opinion analyzing server 200.

The user terminal 100 transmits an opinion analysis request signal, including an opinion analysis target keyword and analysis target period information, to the opinion analyzing server 200 over the communication network. In this case, the user terminal 100 receives a menu or key manipulation of a user to set the opinion analysis target keyword and a period by using a web browser or a dedicated application, transmits the opinion analysis request signal to the opinion analyzing server 200, and receives an opinion analysis result corresponding to the opinion analysis request signal from the opinion analyzing server 200.

When the opinion analysis request signal is received from the user terminal 100 over the communication network, the opinion analyzing server 200 collects a text information including keyword from the database 300, and analyzes the collected text information to generate a summary text.

Moreover, the opinion analyzing server 200 analyzes opinion by setting the opinion analysis target keyword and the period. The opinion analyzing server 200 generates a summary text or summary image of the opinion analysis result, and transmits the generation result to the user terminal 100 over the communication network. At this time, the opinion analyzing server 200 collects a text or an image from the database 300.

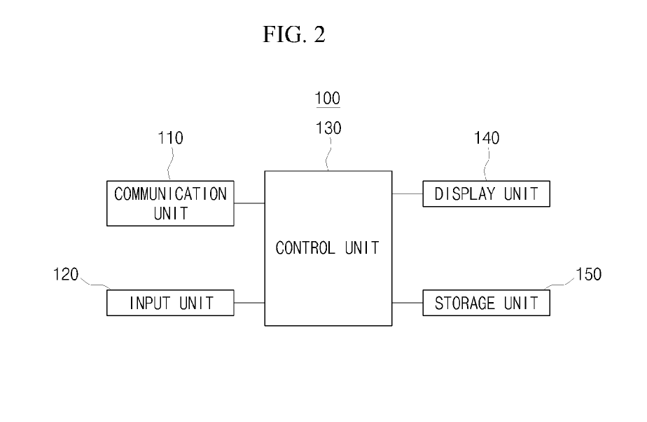

FIG. 2 is a block diagram illustrating a configuration of the user terminal 100 of FIG. 1. Referring to FIG. 2, the user terminal 100 includes a communication unit 110, an input unit 120, a control unit 130, a display unit 140, and a storage unit 150.

Referring to FIGS. 1 and 2, the communication unit 110 of the user terminal 100 transmits or receives data to or from the opinion analyzing server 200 over the communication network.

The input unit 120 receives a web browser or dedicated application execution signal, keywords, and a period setting signal from the user.

The control unit 130 activates the web browser or the dedicated application signal according to the web browser or dedicated application execution signal input through the input unit 120, and transmits the opinion analysis request signal to the opinion analyzing server 200 through the communication unit 110.

The display unit 140 displays the opinion analysis result, received from the opinion analyzing server 200 over the communication network, according to a control of the control unit 130.

The control unit 130 displays the opinion analysis result, received from the opinion analyzing server 200 over the communication network, in the display unit 140, and stores the opinion analysis result in the storage unit 150.

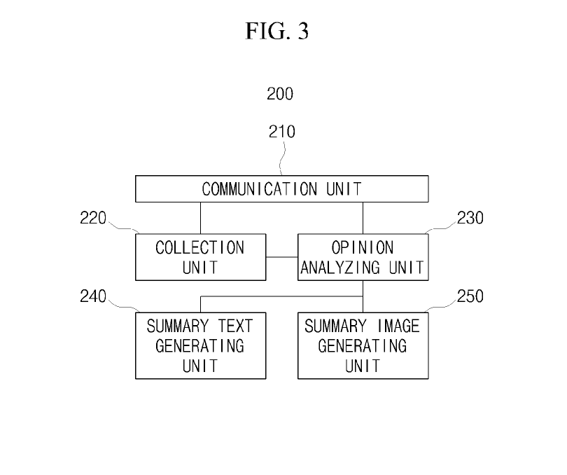

FIG. 3 is a block diagram illustrating a configuration of the opinion analyzing server 200 of FIG. 1.

Referring to FIG. 3, the opinion analyzing server 200 includes a communication unit 210, a collection unit 220, an opinion analyzing unit 230, a summary text generating unit 240, and a summary image generating unit 250.

The communication unit 210 interoperates with the user terminal 100 to receive the opinion analysis request signal including the opinion analysis target keyword and the analysis target period information from the user terminal, and supplies the opinion analysis request signal to the collection unit 220.

The collection unit 220 collects a document including keywords, text information, and an image from the database 300 of FIG. 1 according to the opinion analysis request signal supplied through the communication unit 210, and supplies the collected document, text information, and image to the opinion analyzing unit 230.

The opinion analyzing unit 230 performs an opinion analysis by using the document or text information and image which are supplied from the collection unit 220.

The summary text generating unit 240 and the summary image generating unit 250 respectively generate a summary text and a summary image, which are associated with opinion, according to an analysis result of the opinion analyzing unit 230, and transmit the summary text and the summary image to the user terminal 100 through the communication unit 210. Here, text information which is an opinion (various kinds of sensitivities or views) analysis target is collected from all web data, which is described in a natural language, such as news, Blog Twitter, Facebook, or the like.

The opinion analyzing server 200 according to an embodiment of the present invention compares

predetermined core words by category and words included in the text information collected by the collection unit 220, and when the number of matches between the core words and the words included in the text information is equal to or greater than the predetermined number of times, the opinion analyzing server 200 classifies the text information as a corresponding category, and digitizes an amount of the text information by category to analyze the text information.

However, in the above-described embodiment, for understanding of those skilled in the art, an example of the opinion analysis of the opinion analyzing server 200 according to an embodiment of the present invention has been described above, but the opinion analysis according to an embodiment of the present invention is not limited to an embodiment.

An opinion may be classified as two categories, namely, a positive category and a negative category, and may also be classified as categories which are more subdivided than satisfaction, easiness, fear, and disappointment.

The opinion analyzing server 200 digitizes the amount of the text information by category to analyze the text information. For example, the opinion analyzing server 200 may digitize an opinion, which is classified as a category “satisfaction” of the text information including predetermined keywords, in units of a predetermined period (for example, one hour, or a day).

The opinion analyzing server 200 according to an embodiment of the present invention may classify an opinion for text information, such as a Blog post, a Facebook state message, and a Twitter tweet, by using an opinion classifier which is learned through machine learning, and then count the number of text information corresponding to an arbitrary time range.

However, the opinion analysis of the opinion analyzing server 200 according to an embodiment of the present invention is not limited to the above-described embodiment. For example, an opinion may be digitized (for example, 25%, or 40%) by using a rate at which each opinion category occupies whole opinion within an arbitrary time range, without digitizing an absolute amount of each opinion category.

Moreover, the opinion analyzing server 200 generates a graph of the amount of text information by category based on time according to an analysis result of the text information.

The summary text generating unit 240 of the opinion analyzing server 200 selects representative text information from among pieces of collected text information according to the analysis result of the text information, or lists words, which are included in the text information a predetermined number of times or more, to generate a summary text.

In another embodiment, the summary text generating unit 240 clusters text information collected by the collection unit 220 by using a clustering algorithm, and generates the summary text by using the clustered text information.

In this case, the summary text generating unit 240 may change the text information to a word vector or a morpheme vector to apply the clustering algorithm, or calculate an edit distance, such as a Levenshtein distance, from all text information to perform clustering.

In order to apply the clustering algorithm, k-means clustering or k-nearest neighbors clustering may be used as the predetermined number of clusters, and the number of clusters may be dynamically determined through hierarchical clustering.

When the opinion analyzing server 200 selects the representative text information from among the pieces of collected text information, the opinion analyzing server 200 selects text information, which is closest to a centroid of a cluster, as the representative text information of the cluster to generate the summary text.

The summary image generating unit 240 of the opinion analyzing unit 200 generates the summary image by using keywords-related image information which is collected from the database 300 by the collection unit 220.

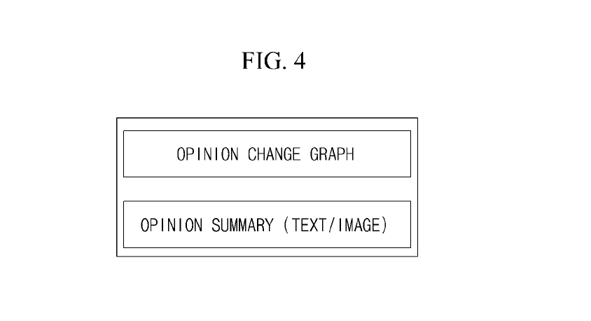

The user terminal 100 receives an analysis result from the opinion analyzing server 200, and as illustrated in FIG. 4, the user terminal 100 displays an opinion change graph and opinion summary (the summary text or the summary image) information in the display unit 140.

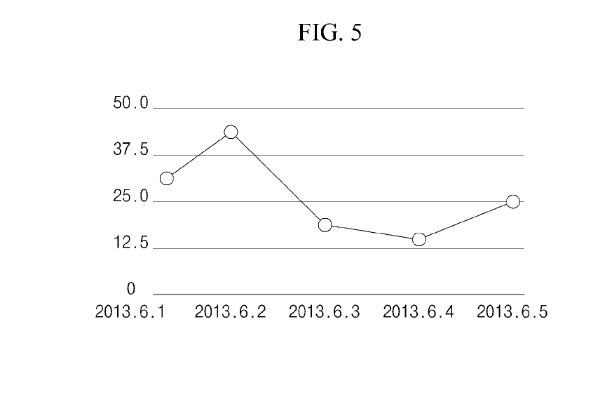

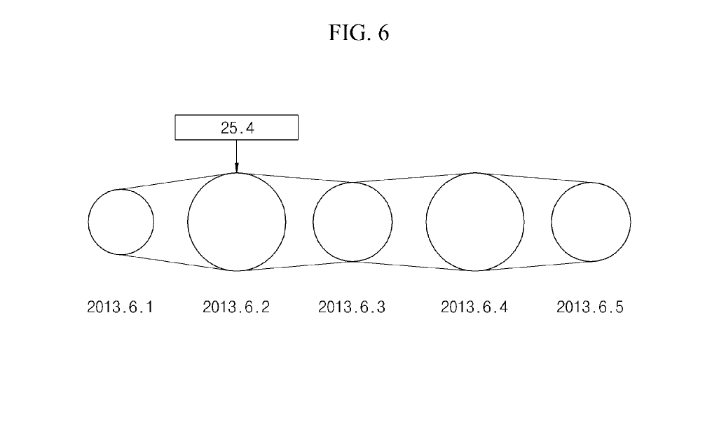

FIGS. 5 and 6 are exemplary diagrams showing graphs of a change amount of single opinion which are displayed by the display unit 140 of the user terminal 100 according to an embodiment of the present invention. FIG. 5 is a graph showing, by day, an increase/decrease progress of an amount of single opinion. In FIG. 5, an X axis indicates date, and a Y axis indicates numerical values. FIG. 6 shows, by day, an increase/decrease progress of an amount of single opinion. However, only when a mouse is located on a circle, a numerical value is shown, and in the other case, an increase/decrease is shown as a size of a circle.

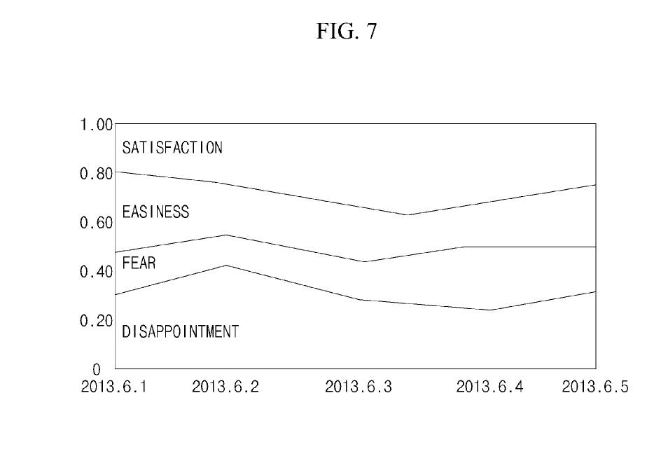

FIG. 7 is an exemplary diagram showing a graph of change progresses of a plurality of opinions according to an embodiment of the present invention, and shows an increase/decrease progress of an opinion in which a category is classified as “satisfaction”, “easiness”, “fear”, and “disappointment” in units of a predetermined analysis target period (for example, a day). Therefore, an opinion change progress between categories based on an elapse of time may be determined.

In the graph of FIG. 7, a Y axis indicates a rate at which each opinion category occupies a whole opinion, instead of an absolute numerical value of each opinion category. For example, when comparing Jun. 1, 2013 and Jun. 2, 2013, a rate at which categories “satisfaction” and “disappointment” occupy increases, but a rate at which categories “easiness” and “fear” occupy decreases.

The graphs of FIGS. 5 to 7 show an increase/decrease progress of opinion in units of a day, but an opinion analysis target period according to an embodiment of the present invention may be a period from a certain time to a specific time, and may be a specific date unit.

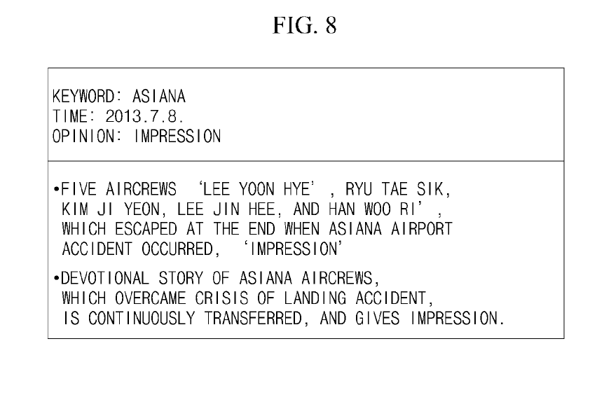

FIGS. 8 to 10 are exemplary diagrams illustrating an opinion summary text according to an embodiment of the present invention.

Referring to FIG. 8, an opinion analysis target keyword is “Asiana”, an analysis target period is Jul. 8, 2013, and a summary text in text information which includes a keyword and corresponds to a category “impression” is illustrated as a summary text.

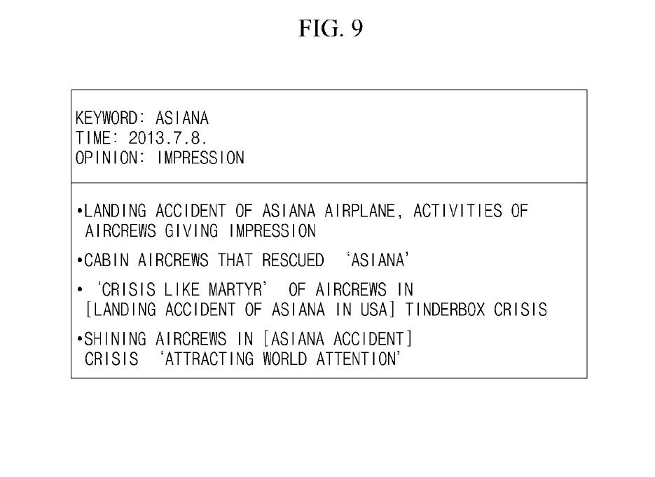

Referring to FIG. 9, the opinion analysis target keyword is “Asiana”, the analysis target period is Jul. 8, 2013, and a representative news article title in the text information which includes the keyword and corresponds to the category “impression” is illustrated as the summary text.

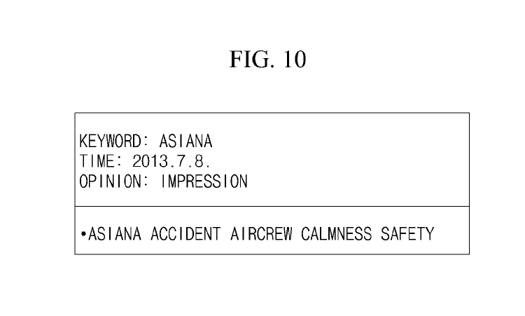

Referring to FIG. 10, the opinion analysis target keyword is “Asiana”, the analysis target period is Jul. 8, 2013, and words (for example, Asiana, accident, aircrew, response, calmness, and safety) which are included a predetermined number of times (for example, five times) in the text information which includes the keyword and corresponds to the category “impression” are listed as the summary text.

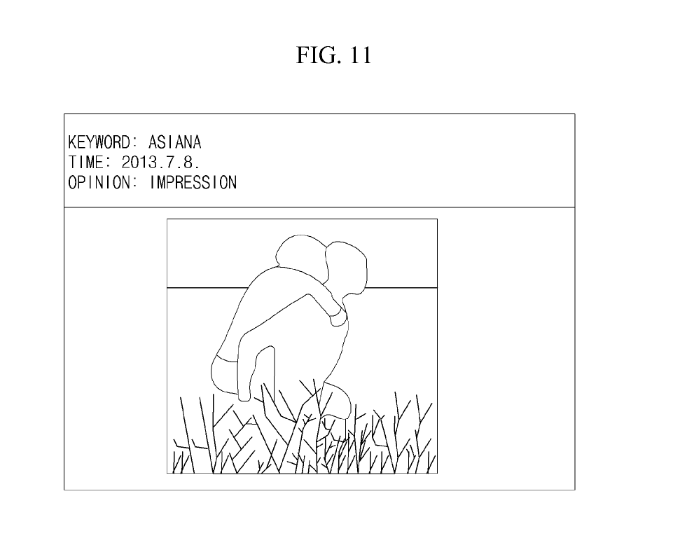

FIG. 11 is an exemplary diagram of an opinion summary image, and illustrates a summary image (which is generated by the summary image generating unit 250) associated with opinion of a category “impression” in image information which is collected by using a keyword (for example, Asiana) and an analysis target period (for example, Jul. 8, 2013).

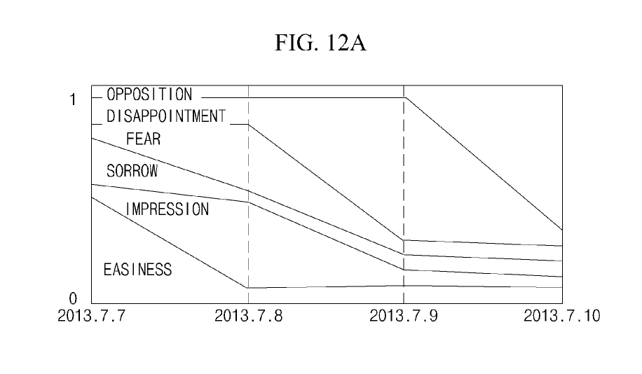

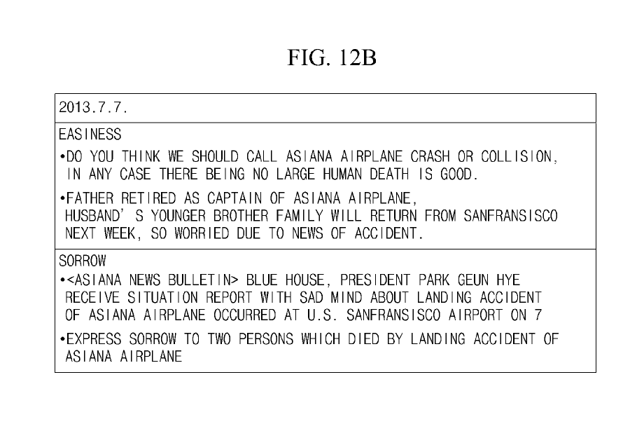

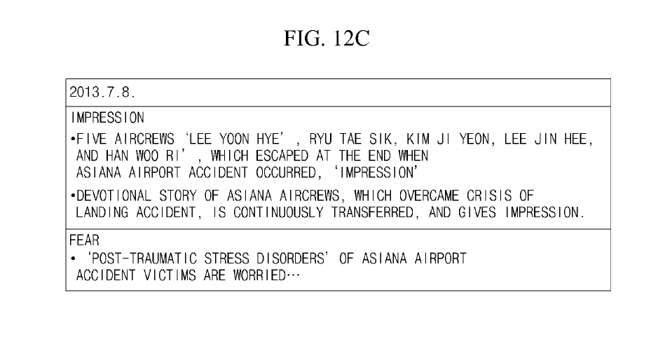

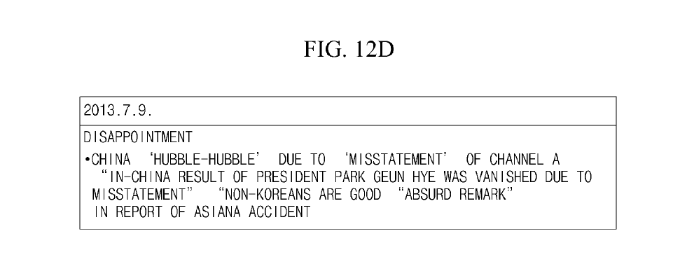

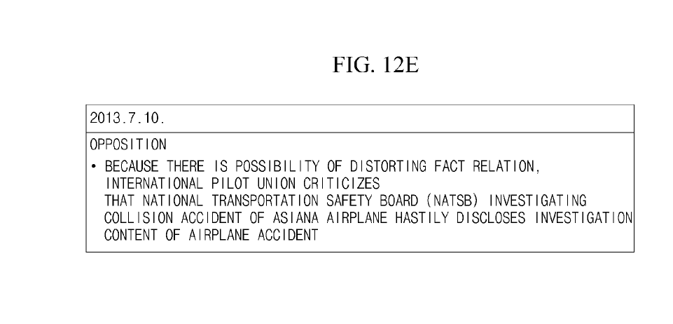

FIG. 12A to 12E is an exemplary diagram illustrating an opinion analysis result based on an elapse of time according to an embodiment of the present invention.

Referring to FIG. 12A, an analysis target keyword which is input through the input unit 120 of the user terminal 100 is “Asiana”, and an analysis target period input through the input unit 120 is a period from Jul. 7, 2013 to Jul. 10, 2013.

The collection unit 220 of the opinion analyzing server 200 collects text information (for example, a tweet of Twitter) from the database 300, and the opinion analyzing unit 230 analyzes the text information, generates a graph of an opinion change progress, and generates and provides summary texts by category (easiness, sorrow, impression, fear, disappoint, and opposition).

That is, according to FIG. 12A, it can be seen from an analysis graph showing a tweet analysis result of the opinion analyzing unit 230 that opinions “easiness” and “sorrow” were dominant in Twitter on Jul. 7, 2013 (i.e., the day of the accident) on which a landing accident of Asiana airplane occurred at Sanfransisco Airport.

A user, which checks an analysis result by using the display unit 140 of the user terminal 100, can check summary texts of categories “easiness” and “sorrow” to know the reason that an opinion for the categories is dominant. It can be seen that there were a lot of opinions in which human death being small is easy, and there were a lot of opinions in which the accident victims cause sorrow.

According to FIG. 12C, it can be seen that opinions for categories “fear” and “impression” rapidly increased on Jul. 8, 2013, in comparison with the day before the day of the accident. It can be checked from summary texts of the categories that there were a lot of opinions in which devotion of aircrews for evacuating passengers is impressed, and there were a lot of opinions in which post-traumatic stress disorders of the accident victims are worried.

According to FIG. 12D, it can be checked from the graph that opinions for a category “disappointment” rapidly increased on Jul. 9, 2013. It can be checked from an opinion for the category that an opinion, in which a misstatement “a victim not being Korean is fortunate” of a report media causes disappointment, was dominant.

According to FIG. 12E, it can be checked from the graph that opinions for a category “opposition” rapidly increased on July 10. It can be checked from a summary text of the category that an opinion, in which the international pilot union criticizes that the national transportation safety board hastily discloses investigation content of the airplane accident, was dominant.

The opinion analysis result including the graph and summary text of FIGS. 12 A to 12E has been merely described as an example that enables those skilled in the art to easily understand an embodiment of the present invention. Implementation of an opinion analyzing method according to an embodiment of the present invention is not limited to the example.

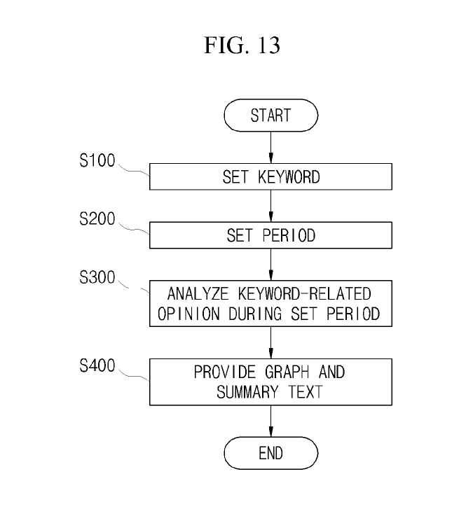

FIG. 13 is a flowchart illustrating an opinion analyzing method based on an elapse of time according to an embodiment of the present invention.

Referring to FIG. 13, first, the opinion analyzing method based on an elapse of time according to an embodiment of the present invention sets a keyword of an opinion analysis target and a search period of the opinion analysis target in steps S100 and S200.

In step S300, the opinion analyzing method analyzes text information of an opinion including the keyword according to the keyword and search period which are set in steps S100 and S200.

In step S400, the opinion analyzing method provides a graph and a summary text as the analysis result of the text information of the opinion which is obtained in step S300.

Here, step S300 collects the text information which is generated during the search period which is set in step S200 and includes the keyword which is set in step S100.

Step S300 classifies the collected text information by predetermined category, and digitizes an amount of the text information by category to analyze the text information.

In another embodiment, step S300 compares a match between words included in the collected text information and predetermined words by category, counts the number of matches, and when the number of matches is equal to or greater than the predetermined number of times, classifies the text information as a category corresponding to the predetermined words.

However, the above-described embodiment of step S300 is merely for understanding of those skilled in the art, and is not limited to the above-described example. As another example of the text information analyzing method in step S300, the opinion analyzing method according to an embodiment of the present invention may classify an opinion for text information, such as a Blog post, a Facebook state message, and a Twitter tweet, by using an opinion classifier which is learned through machine learning, and then count the number of text information corresponding to an arbitrary time range.

In step S400, the opinion analyzing method generates a graph of an amount of text information by category based on time by using the analysis result of the text information which is obtained in step S300. In this case, the opinion analyzing method generates a graph of a change progress of single opinion based on time as shown in FIGS. 5 to 7, or generates a graph of change progresses of a plurality of opinions.

The opinion analyzing method based on an elapse of time according to an embodiment of the present invention further includes an operation that collects keyword-related image information from a database, and generates and provides a summary image according to the analysis result of step S300.

Moreover, step S400 clusters the collected text information by using the clustering algorithm, and selects and provides representative text information from among pieces of the clustered text information, or lists words, which are included in the clustered text information a predetermined number of times or more, to provide a summary text.

Here, step S400 has been described as only an example for understanding of those skilled in the art, and is not limited to the above-described example.

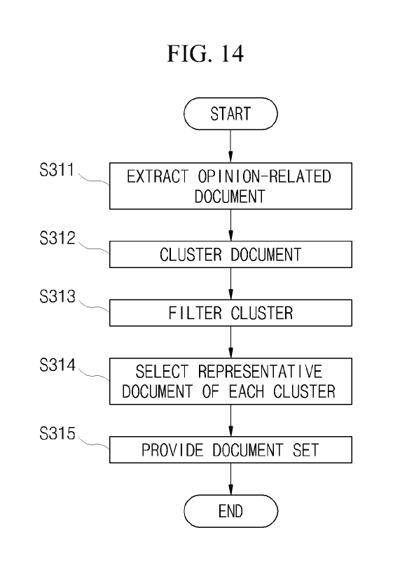

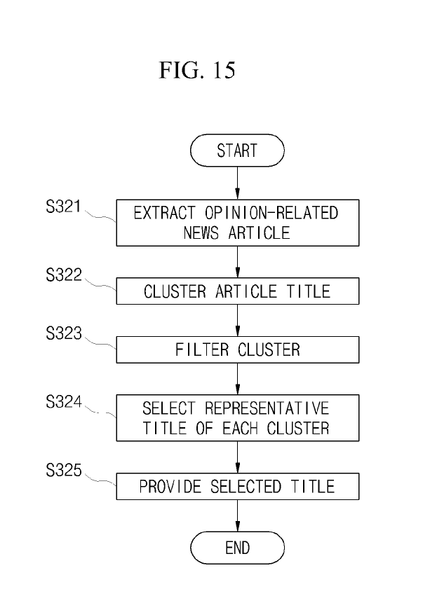

FIG. 14 is a flowchart illustrating a process of selecting a representative document in an opinion analyzing method based on an elapse of time according to an embodiment of the present invention. FIG. 15 is a flowchart illustrating a process of extracting a title of a representative news article in an opinion analyzing method based on an elapse of time according to an embodiment of the present invention.

Referring to FIG. 14, first, the process of selecting a representative document for generating summary text information extracts an opinion-related document associated with a keyword in step S311.

The process clusters the opinion-related document, which is extracted in step S311, by using the clustering algorithm in step S312.

In step S313, the process filters a small or irrelevant document from a plurality of clusters which are obtained in step S312. In step S314, the process selects a representative document of each of the plurality of clusters. In step S315, the process supplies the selected representative document to a user. Here, step S314 selects a document, which is closest to a centroid of a cluster, as the representative document.

Referring to FIG. 15, first, the process of extracting a representative news article title for generating summary text information extracts a news article associated with an opinion in step S321.

In step S322, the process clusters a news article title, which is extracted in step S321, by using the clustering algorithm.

Subsequently, in step S323, the process filters out a news article title irrelevant to the clustered news article title which is obtained by using the clustering algorithm.

In step S324, the process selects a representative news article tile of each of a plurality of clusters. In step S325, the process provides the selected representative news article title.

As described above, the opinion analyzing system and method based on an elapse of time analyze and provide a change progress of opinion depending on input keywords and a predetermined period, thereby intuitively determining an opinion change in each of images of an event, a brand, and a person which are recognized by the public.

Moreover, according to the embodiments of the present invention, users' satisfaction for a specific product or service can be easily determined, and it is possible to trace a change process of public opinion for a specific policy. Also, the opinion analyzing system and method may be applied to a marketing or crisis counterstrategy.

Moreover, according to the embodiments of the present invention, opinion is analyzed, and change progress information of the analyzed opinion is provided by using a text or an image, thereby easily determining bases of various opinions.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An opinion analyzing server based on an elapse of time, the opinion analyzing server comprising:
a communication unit configured to receive an opinion analysis request signal, including an opinion analysis target keyword and analysis target period information, from a user terminal;
a collection unit configured to collect text information including the opinion analysis target keyword from a database according to the opinion analysis request signal which is received via the communication unit; and
an opinion analyzing unit configured to analyze the text information collected by the collection unit, and provide opinion information according to the analysis result.

2. The opinion analyzing server of claim 1, wherein the opinion analyzing unit classifies, by predetermined category, the text information collected by the collection unit, and digitizes an amount of the text information by category to analyze the text information.

3. The opinion analyzing server of claim 2, wherein the opinion analyzing unit counts number of matches between words included in the text information collected by the collection unit and predetermined core words by category, and classifies the text information by category according to the count result.

4. The opinion analyzing server of claim 1, further comprising a summary text generating unit configured to generate a summary text according to the text information analysis result of the opinion analyzing unit.

5. The opinion analyzing server of claim 4, wherein the summary text generating unit clusters the text information collected by the collection unit by using a clustering algorithm, and generates the summary text by using the clustered text information.

6. The opinion analyzing server of claim 1, wherein the collection unit collects the text information from web data which is described in a natural language, and collects image information associated with the opinion analysis target keyword.

7. The opinion analyzing server of claim 6, further comprising a summary image generating unit configured to generate a summary image by using the image information collected by the collection unit according to the text information analysis result of the opinion analyzing unit.

8. An opinion analyzing method based on an elapse of time, the opinion analyzing method comprising:
setting a keyword and search period of an opinion analysis target;
analyzing text information of an opinion based on the set keyword and search period; and
providing, as a graph and a summary text, opinion information about the analysis result of the text information.

9. The opinion analyzing method of claim 8, wherein the analyzing comprises:
collecting text information which is generated during the set search period and associated with the set keyword;
classifying the collected text information by predetermined category; and
digitizing an amount of the classified text information by category to analyze the text information.

10. The opinion analyzing method of claim 9, wherein the analyzing comprises:
counting number of matches between words included in the collected text information and predetermined words by category; and
when the number of matches is equal to or greater than predetermined number of times, classifying the text information as a category corresponding to the predetermined words.

11. The opinion analyzing method of claim 9, wherein the providing of opinion information comprises generating a graph of an amount of the text information by category based on time by using the analysis result of the text information.

12. The opinion analyzing method of claim 8, further comprising collecting image information associated with the keyword, and generating and providing a summary image according to the analysis result of the text information.

13. The opinion analyzing method of claim 9, wherein the providing of opinion information comprises clustering the collected text information by using a clustering algorithm, and selecting and providing representative text information from among pieces of the clustered text information, or listing words, which are included in the clustered text information a predetermined number of times or more, to provide a summary text.

14. An opinion analyzing system based on an elapse of time, the opinion analyzing system comprising:
a user terminal configured to transmit an opinion analysis request signal including an opinion analysis target keyword and analysis target period information; and
an opinion analyzing server configured to, when the opinion analysis request signal is received from the user terminal, collect text information associated with the opinion analysis target keyword from a database according to the opinion analysis request signal, and analyze the collected text information to generate a summary text of an opinion.

15. The opinion analyzing system of claim 14, wherein the opinion analyzing server classifies the collected text information by predetermined category, and digitizes an amount of the text information by category to analyze the text information.

16. The opinion analyzing system of claim 15, wherein the opinion analyzing server compares predetermined words by category and words included in the collected text information to count number of matches therebetween, and when the number of matches is equal to or greater than predetermined number of times, classifies the text information as a corresponding category.

17. The opinion analyzing system of claim 14, wherein the opinion analyzing server generates a graph of an amount of the text information by category based on time according to the analysis result of the text information.

18. The opinion analyzing system of claim 14, wherein the opinion analyzing server selects representative text information from among pieces of the text information according to the analysis result of the text information, or lists words, which are included in the text information a predetermined number of times or more, to generate the summary text.

19. The opinion analyzing system of claim 14, wherein the opinion analyzing server collects image information associated with the opinion analysis target keyword from the database, and generates a summary image by using the collected image information.
